(19) United States
(12) Patent Application Publication
(10) Pub. No.: US 2014/0036618 A1
(43) Pub. Date: Feb. 6, 2014

(54) DEVICE FOR BRINGING A LIQUID SPECIES INTO CONTACT WITH A GROWING PARTICULATE SOLID SPECIES

(71) Applicants: Céline Levecq, Paris (FR); Thomas Thouvenot, Maisons Laffitte (FR)

(72) Inventors: Céline Levecq, Paris (FR); Thomas Thouvenot, Maisons Laffitte (FR)

(73) Assignee: VEOLIA WATER SOLUTIONS & TECHNOLOGIES SUPPORT, Saint Maurice (FR)

(21) Appl. No.: 13/984,565

(22) PCT Filed: Feb. 10, 2010
(86) PCT No.: PCT/FR12/50307

§ 371 Date: Oct. 17, 2013

(30) Foreign Application Priority Data
Feb. 11, 2011 (FR) 1151139

(51) Int. Cl. B01F 3/12

(52) U.S. Cl. CPC B01F 3/1271
USPC 366/302

(57) ABSTRACT

The invention relates to an expanding device for combining a liquid species and a particulate solid species, which includes a vessel 200 in which a stirrer 800 having paddles that rotate about a shaft 810 is arranged, the stirrer being optionally provided with a flow guide tube 210, wherein the vessel 200 also includes a static obstacle 830 that is generally centred around said shaft and aligned with the stirrer, characterised in that the static obstacle 830 has, in a plane passing through the shaft, an outer transverse dimension that increases as it moves away from the stirrer 800 parallel to said shaft 810, having a constant or increasing slope relative to said shaft.

The invention relates to a device for bringing a liquid species into contact with a growing particulate solid species, applicable to the treatment of particle-laden industrial and urban wastewater, which it is desired to homogenize, and to the purification treatment of water intended for consumption or for industrial processes requiring particularly clean water.

The invention applies in particular to the flocculation treatments of a fluid to be treated. For example, it applies to Actiflo® technology, which is a clarification system using an addition of microsand and flocculating polymer to the effluent in order to cause ballasted flocculation, i.e. a growth of flocs around a ballast constituted by the particles of microsand. The water is stirred with a blade stirrer in order to create adherence. Prior to the treatment, a coagulant such as ferric chloride can be added in order to remove the charge from the colloids.

The invention also applies to precipitation treatments of industrial wastewater aimed at recovering mineral material such as gypsum or lime scale in the form of crystals. A homogenization of the fluid is desired, in order to allow for particle size control. Similarly, water-softening methods aimed at the removal of the lime scale therefrom for a specific industrial use are also based on the precipitation of lime scale.

In these systems, stirring is set up in order to ensure homogenization. It is necessary for this stirring to be compatible with the growth of the aggregates of the solid species, despite the obstacles constituted by the side walls of the vat, which the aggregates will knock against if they are moving at a velocity comprising a significant radial component.

In order to meet these specifications, it is possible to choose a blade stirrer capable of providing a thrust that is more longitudinal than radial. Furthermore, it is possible to insert the blade stirrer into a flow-guide tube the shaft of which is aligned with that of the blade stirrer. The flow-guide tube ensures the compartmentalization of the vat between the inside of the flow-guide tube, where the current is downward, and the outside of the flow-guide tube, where the current is upward. The radial component of the currents is greatly reduced, which ensures a harmonious growth of the solid species aggregates, which do not collide with the side walls.

Thus, an optimized version of Actiflo®, called Turbomix®, is based on a single vat comprising a flow-guide tube, a stirrer in the flow-guide tube and a cruciform baffle opposing the rotation of the flow leaving the flow-guide tube, which allows for a reduction in the size of the installations, energy savings and facilitated retreatment of the flocs. It is described in the document WO 2005/065832.

In the different situations mentioned, in which a liquid species is brought into contact with a growing solid species, with the aim of improving the available techniques, a possible improvement remains the most complete possible elimination of the residual shear effects in the known processes. These shears, not recognized by the prior art, have the effect of dislocating the flocs or crystals and therefore oppose the satisfactory progress of their growth process. More particularly, vortices appear in certain configurations, and they have the double disadvantage of uselessly dissipating energy and causing shears in the vat.

In order to solve this problem, the present invention consists of a device for bringing a liquid species into contact with a growing particulate solid species, comprising a vat in which is arranged a blade stirrer rotating about a shaft, the stirrer being optionally provided with a flow-guide tube, the vat moreover comprising a static obstacle generally centred about said shaft in the extension of the stirrer, characterized in that the static obstacle has an outer transverse dimension that increases moving away from the stirrer parallel to said shaft, with a constant or increasing slope relative to this shaft.

By outer transverse dimension is meant here the dimension extending from one side to the other of the outer surface in axial cross-section (a diameter in the case of a rotational shape), and not the distance to the shaft from a given point on this surface (a radius in the abovementioned case of a rotational shape).

This device provides effective homogenization of the mixture with low energy consumption, and a reduction in the shear effects observed in the prior devices. The solid particles follow moderately curved U-shaped paths and rise again rapidly along the side walls of the vat, and do not remain deposited in the extension of the stirrer. The particulate solid species grows rapidly, and it is possible to reduce the stirring speed.

The installation of a static obstacle in the extension of a stirrer combined with a flow-guide tube was already known from document KR 2006/0114644, which describes an instantaneous dissolving device including a lower stirrer outside the flow-guide tube combined with a widening of the flow-guide tube at its lower opening, which are indispensable for creating the random movements necessary for the rapid dissolving of the solid species introduced; it is in fact understood that, since the lower opening of the flow-guide tube is flared, only part of the downward flow intercepts this lower stirrer whilst another part of this flow circulates horizontally at the outlet of the tube, which causes turbulence favourable to dissolution when these two parts telescope; a small component arranged in the extension of the shaft helps to guide the flow. It should be noted that since this document relates to an instantaneous dissolving device, its components are designed so as to cause significant turbulence suitable for promoting dissolution, which is contrary to the invention which by contrast aims to retain a growing solid phase.

Moreover, from the document U.S. Pat. No. 6,345,810, an aerating device is known comprising a stirrer in the extension of which a dome is arranged, in the centre of which an air-injection channel opens; the stirrer, the motor of which prevents a downward vertical flow along the shaft, has the aim of stirring the liquid laterally while causing the air bubbles to burst so as to optimize the aeration effect. The dome has a profile the slope of which relative to the shaft reduces as it moves further away. Since this document relates to atomizing the air bubbles that arrive, its components are not compatible with a device aimed at retaining a growing solid phase.

According to advantageous features, the stirrer and the static obstacle are shaped and/or dimensioned and/or positioned in mutual dependence.

Thus, advantageously, the static obstacle is covered axially by the stirrer and/or by the flow-guide tube if this exists; in other words, as the flow in practice takes place downwards, the stirrer and/or the flow-guide tube extend at least approximately, with their bottom part, down to the level of the top part of the static obstacle; the covering effect of the stirrer and/or of the flow-guide tube is due to the fact that their respective bottom parts are in practice situated at a distance from the shaft whereas the top part of the static obstacle is in a central configuration.

Preferably, the static obstacle and the stirrer are at least at one point (in an axial plane) longitudinally separated by a distance less than the longitudinal dimension of the stirrer. This feature guarantees the minimal character of the counter-current speed components at the shaft between the stirrer and the static obstacle and optimizes the synergy between the stirrer and the static obstacle in order to ensure a continuous transition of the paths of the downward flow.

According to another advantageous feature of the invention, the maximum value of the outer transverse dimension of the static obstacle is at least equal to the maximum transverse dimension of the stirrer and/or the flow-guide tube when it exists. This guarantees that all of the flow provided by the stirrer or by the flow-guide tube is intercepted by the obstacle and is progressively guided towards gentle U-shaped paths.

According to another advantageous feature of the invention, the axial dimension of the static obstacle is at most equal to half of the maximum value of said outer transverse dimension, or even at most equal to one-third of this value. This guarantees that the obstacle guides the flow until it is subjected to a significant radial component.

According to another advantageous feature of the invention, the outer surface of the static obstacle has, in any plane passing through the shaft, an average inclination of at least 45° with respect to this shaft; this contributes to the abovementioned effects; in fact, when the static obstacle has a top part with a small cross-section, in the form of an optionally blunt tip, the previous feature is also achieved in practice.

According to another advantageous feature of the invention, the outer surface of the static obstacle is connected to the bottom of the vat at least approximately tangentially, at an angle of at most 15°. This contributes to optimizing the synergy between the static obstacle and the wall to which it is fixed, in practice the bottom of the vat, in guiding the flow in its U-shaped paths.

The slope of the outer surface of the static obstacle can, in a particularly simple configuration from a geometric point of view, be constant from the top of the obstacle to the wall to which this obstacle is fixed; however, according to another advantageous feature, the outer surface of the static obstacle comprises at least one zone which, in an axial plane, is dished with a concavity oriented away from the shaft. It is understood that, the more the outer surface of the static obstacle is dished, the more significant is the effect of guiding and accompanying the flow.

According to an advantageous feature, a radius of curvature of the static obstacle, called first radius of curvature, taken in a plane comprising the shaft, is comprised between one quarter of a reference transverse dimension of the vat and once, or one and a half times said reference transverse dimension of the vat. By reference transverse dimension is meant generally a transverse dimension of the volume of vat in which the stirrer extends its influence; in practice, for reasons of minimizing the space required, this is the minimum transverse dimension of the vat, for example a side of the bottom of this vat, when it is rectangular or square. This feature, which relates to a precise dimensioning of the static obstacle in relation to the dimensions of the base of the vat, makes it possible to minimize the counter-current speed components in the extension of the shaft of the stirrer, allowing the particulate solid species to grow rapidly, and the operator to reduce the stirring speed.

According to an advantageous feature of the invention, the dished appearance of the outer surface results from the fact that the outer surface of the static obstacle comprises an axial succession of portions with constant slopes, these slopes increasing (with respect to the shaft) from one portion to another moving away from the stirrer. Such a configuration can have advantages in terms of production.

According to another advantageous feature, the static obstacle has overall generally regular shape about the shaft, for example a rotational shape. This contributes to obtaining a good axial symmetry of the dishing of the paths of the various fractions of the downward flow. In particular in such a case, the static obstacle comprises at least two ribs along its outer surface. These extend away from the central portion of the static obstacle, in a radial, or even both radial and circumferential manner. Preferably there is one rib per base corner of the vat, each corner being in the extension of a rib, which allows for shear phenomena to be reduced while making the best possible use of the space in the vat. There can be more ribs than there are base corners of the vat.

According to another possible shape of the outer surface of the static obstacle, this outer surface of the static obstacle has the shape of a pyramid formed by a circumferential succession of facets separated by edges. It must be remembered that the notion of a pyramid implies the presence of facets, which are plane or dished, in any number, which can be equal to 4, or even less (3 facets) or more (often an even number, such as 6 or 8). It is understood that such a configuration leads to a certain ease of production. When the facets are dished, they are advantageously formed from portions of a cylinder in the mathematical sense of the term, i.e. portions of a surface formed by the movement of a straight line (parallel to the bottom of the vat) along a generatrix (in this case situated in practice in a plane containing the shaft). Such a configuration combines simplicity of production and good flow guidance.

Particularly advantageously, the bottom comprises, at least in the extension of the edges, ribs extending transversally from the shaft. It is understood that these ribs, when they are integral with the static obstacle, can help to fix the static obstacle securely to the bottom of the vat; moreover, when these ribs extend to corners of this bottom, it is understood that these ribs can moreover help to hold the static obstacle securely in position with respect to the corners of this bottom.

Preferably, the blades are twisted, i.e. their inclination with respect to the shaft varies from the shaft towards the ends of these blades, for example increasing. According to an alternative, the blades are bent, i.e. they comprise, separated by a bending line generally diverging from the shaft (but not necessarily coplanar with this shaft), two upstream and downstream portions with constant slopes with respect to the shaft.

Whatever the particular shape of the blades, they advantageously have, at least at their ends, an angle of attack comprised between 35° and 55° with respect to the shaft; this angle of attack is the angle of inclination of the blades close to their of attack, namely in this case close to their upper edges. This contributes to good axial entrainment of the flow.

According to another advantageous feature of the invention, the maximum value of the outer transverse dimension of the static obstacle represents at least one third of the smallest transverse dimension of the bottom to which this static obstacle is fixed (it is an order of magnitude, such that this condition includes in particular a value of about 30%). This guarantees an effect which guides the flow over a substantial fraction of the surface area of this bottom.

According to yet another feature of the invention, a flow-guide tube is effectively present, i.e. the stirrer is inserted at least partially (or even completely) into a flow-guide tube. When the stirrer is inserted only partially into a flow-guide tube, then, according to an advantageous feature, it extends beyond the opening of the flow-guide tube by at least 5% and at most 60% of its dimension measured parallel to the shaft, and preferentially at least 15% and at most 45%. This feature makes it possible to limit the shear linked to the walls of the flow-guide tube meeting the radial component of the currents created by the blades, which exists even if the stirrer has been designed with care.

According to another advantageous feature, in a plane comprising the shaft, the internal surface of the blades has a projection parallel to the outer surface of the static obstacle. This feature makes it possible to limit the shear phenomena in the space between the obstacle and the blades. It is preferably implemented over the greatest distance possible.

According to another advantageous feature, in a plane comprising the shaft, the outer surface of the blades has a circular projection a radius of curvature of which, called second radius of curvature, is comprised between one-eighth of a reference transverse dimension of the vat and a half of said reference transverse dimension of the vat.

Generally, this feature, which relates to a dimensioning of the blades in relation to the dimensions of the base of the vat, makes it possible to limit the shear phenomena at the end of the blade.

According to another advantageous feature, in a plane comprising the shaft, the outer surface of the blades has a circular projection a radius of curvature of which, called second radius of curvature, is comprised between half of a radius of curvature, called first radius of curvature, of the outer surface of the static obstacle and twice said radius of curvature, called first radius of curvature, of the outer surface of the static obstacle.

Generally, this feature, which relates to a dimensioning of the blades in relation to the dimensions of the static obstacle, makes it possible to limit the shear phenomena and the formation of vortices.

The invention also relates to a method of bringing a liquid species and a growing particulate solid species into contact within a vat, according to which, by means of a blade stirrer rotating about a shaft, the stirrer being optionally provided with a flow-guide tube, the two species are mixed and entrained along this shaft, towards a static obstacle generally centred around said shaft in the extension of the stirrer, characterized in that generally U-shaped paths are imposed on the mixed species via the static obstacle, the static obstacle having an outer transverse dimension that increases moving away from the stirrer parallel to said shaft, with a constant or increasing slope with respect to this shaft.

The invention also relates to the process of dimensioning the assembly formed by the contact vat, the stirrer and a static obstacle installed in the vat.

The invention will now be described with reference to the attached figures.

FIG. 1 shows a stirrer used, generally, in the contact devices.

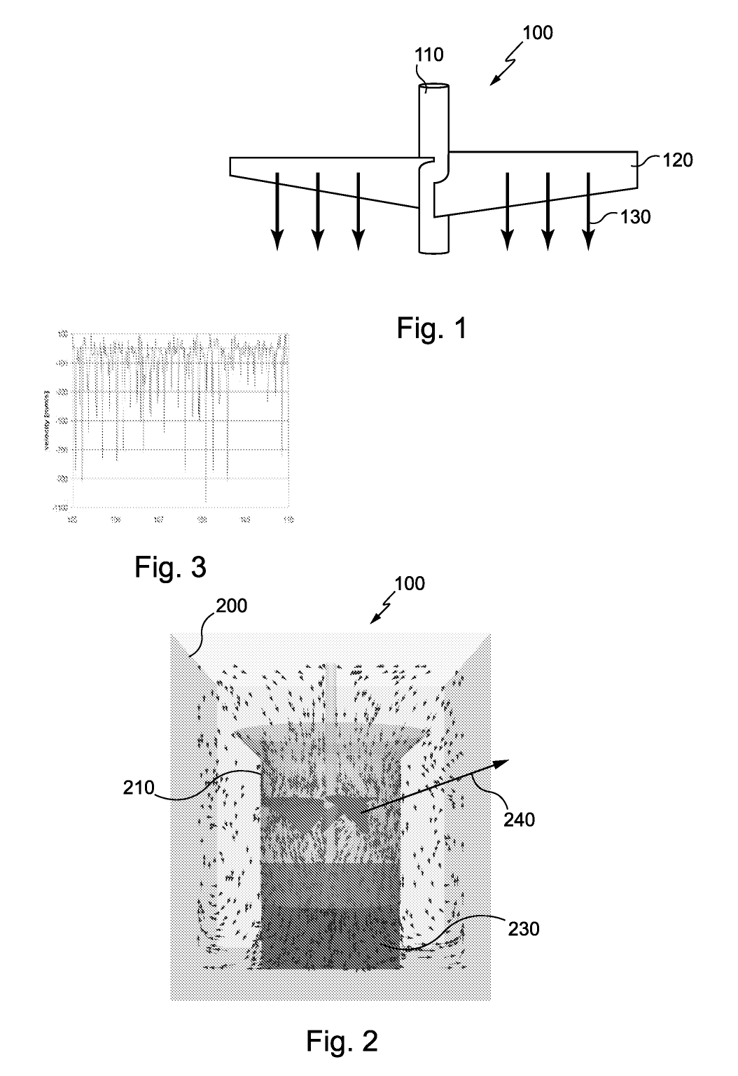

FIG. 2 shows the hydraulic flows in a vat according to the prior art.

FIG. 3 shows the speed variations measured at a point in the vat according to FIG. 2.

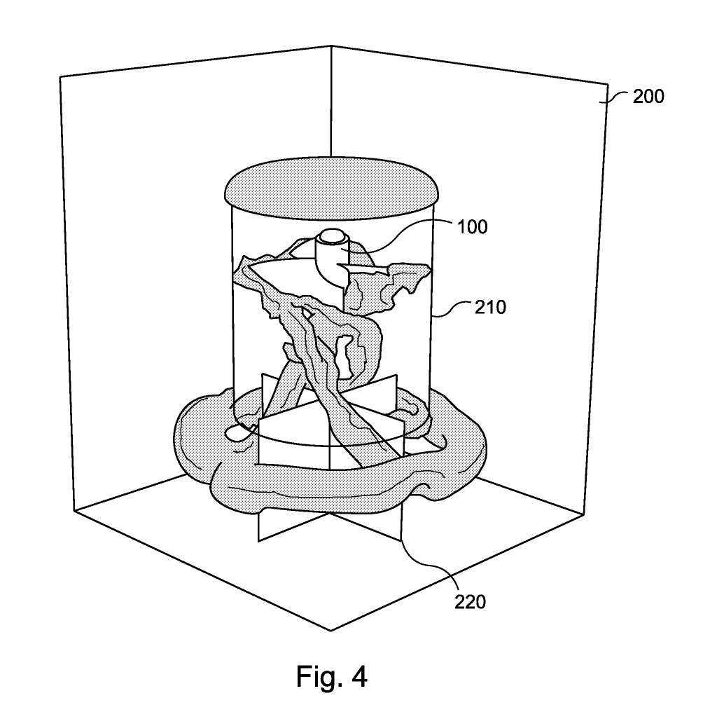

FIG. 4 shows the low pressure zones in a vat according to the prior art.

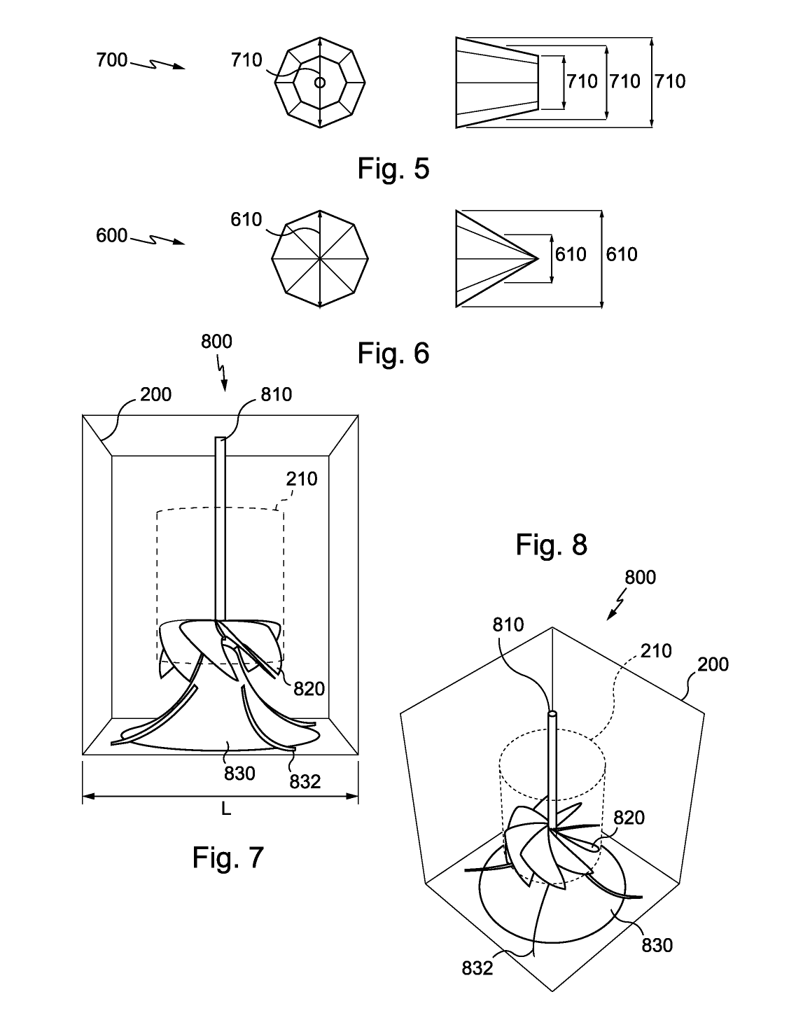

FIGS. 5 and 6 show two static obstacles that can be used, according to the invention, in the bottom of the vat.

FIGS. 7 and 8 show a first embodiment of the invention.

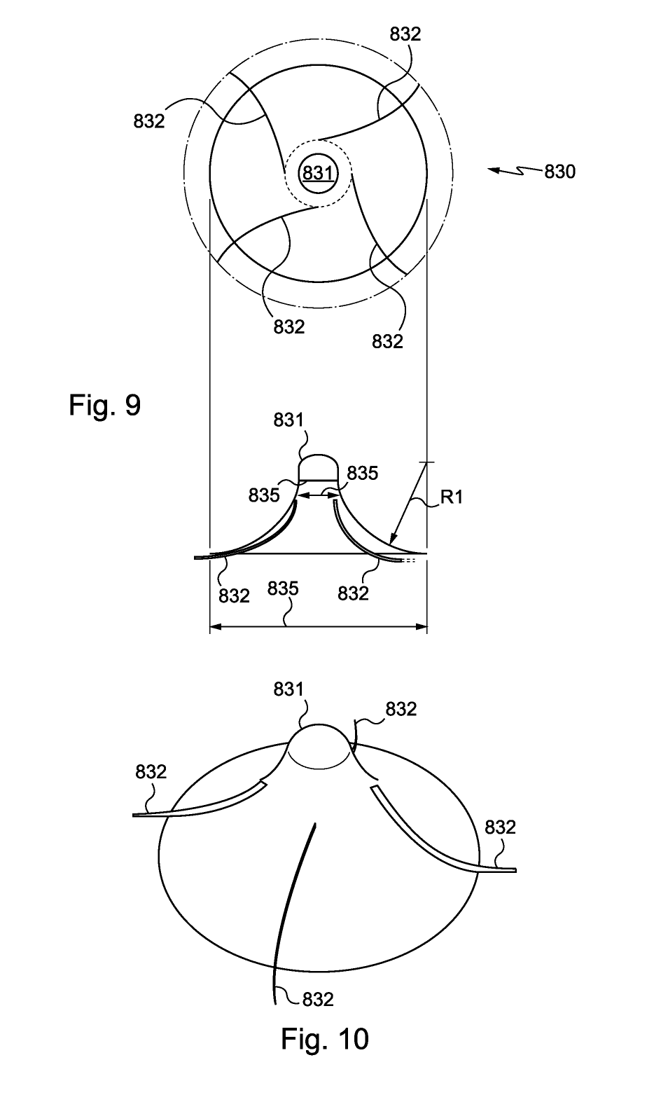

FIGS. 9 and 10 show more precisely an embodiment of a static obstacle used in the bottom of the vat in this first embodiment of the invention.

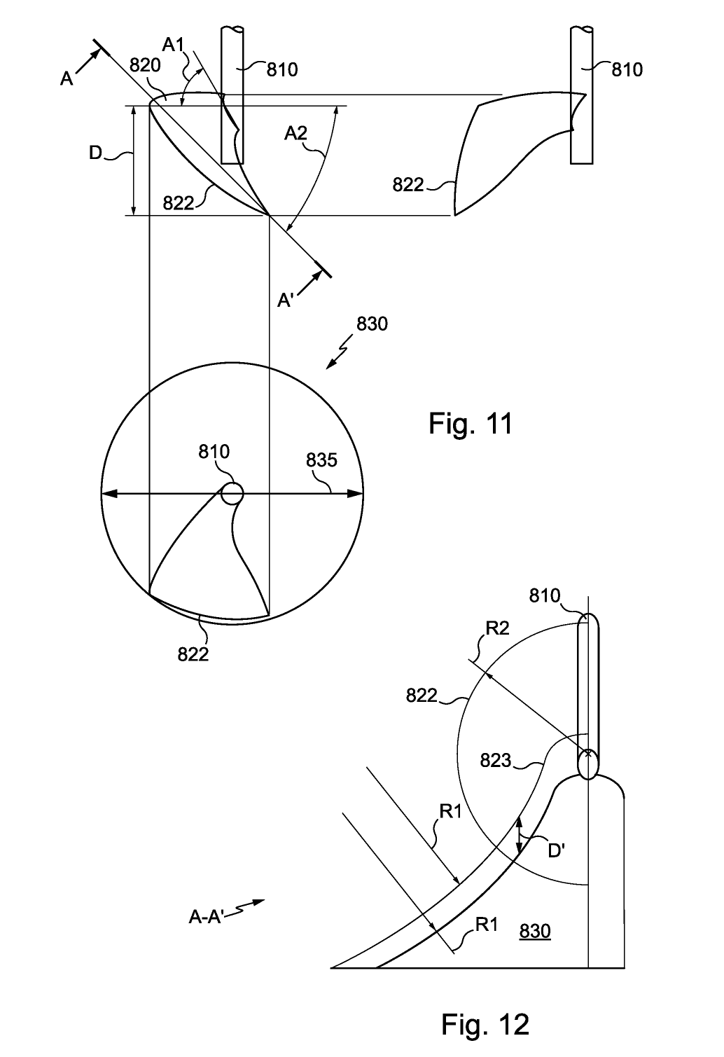

FIGS. 11 and 12 show more precisely the stirrer used in this embodiment of the invention.

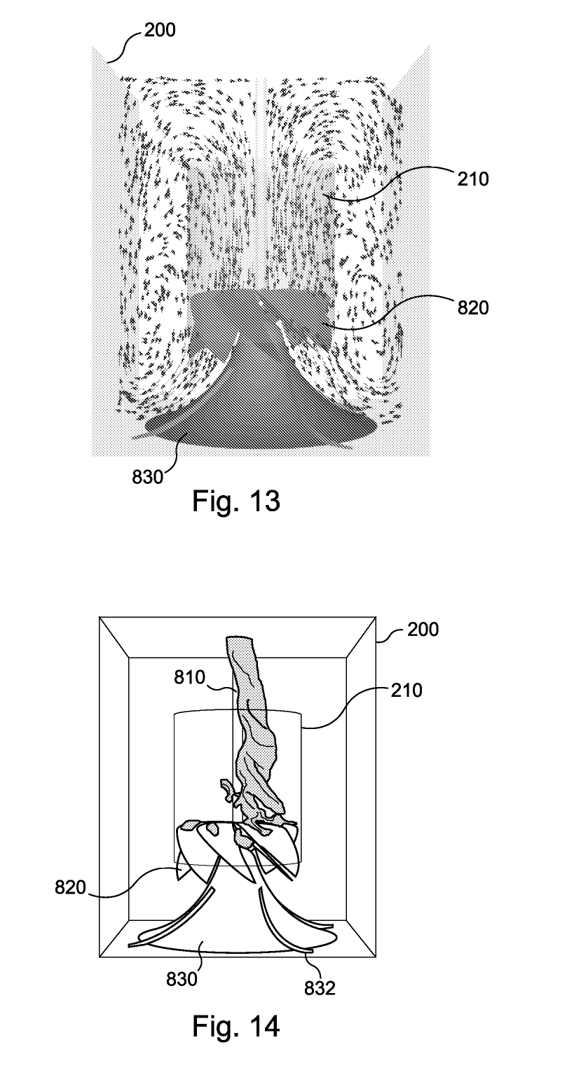

FIG. 13 shows the flow speeds in a vat incorporating the invention.

FIG. 14 shows the low pressure zones in a vat according to the invention.

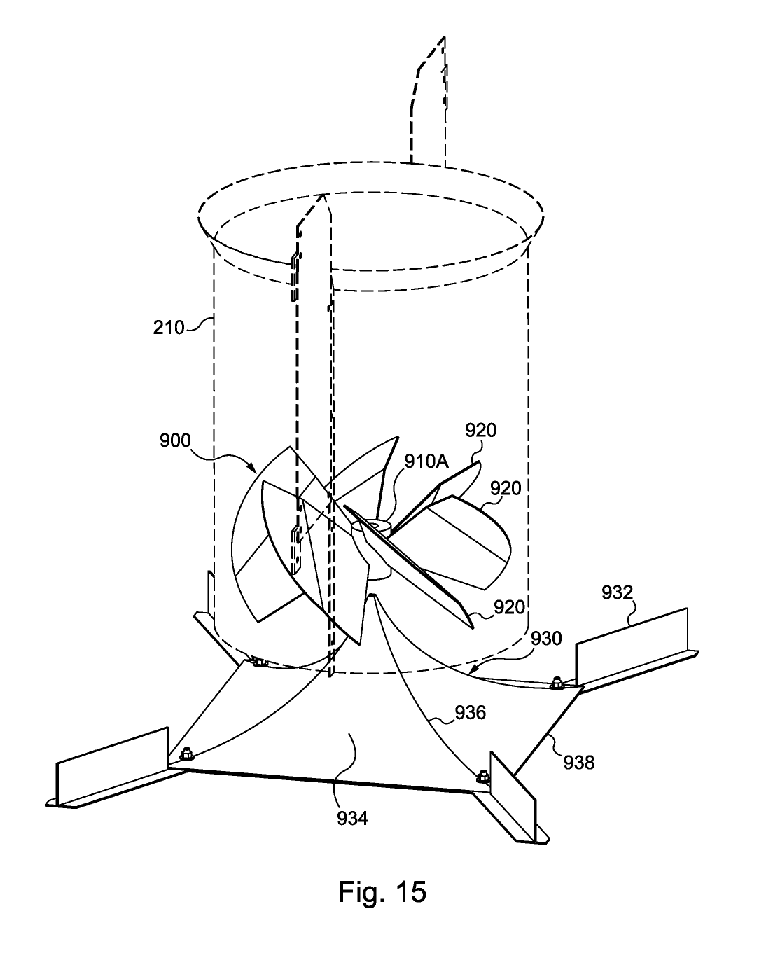

FIG. 15 shows in perspective a second embodiment of a device according to the invention.

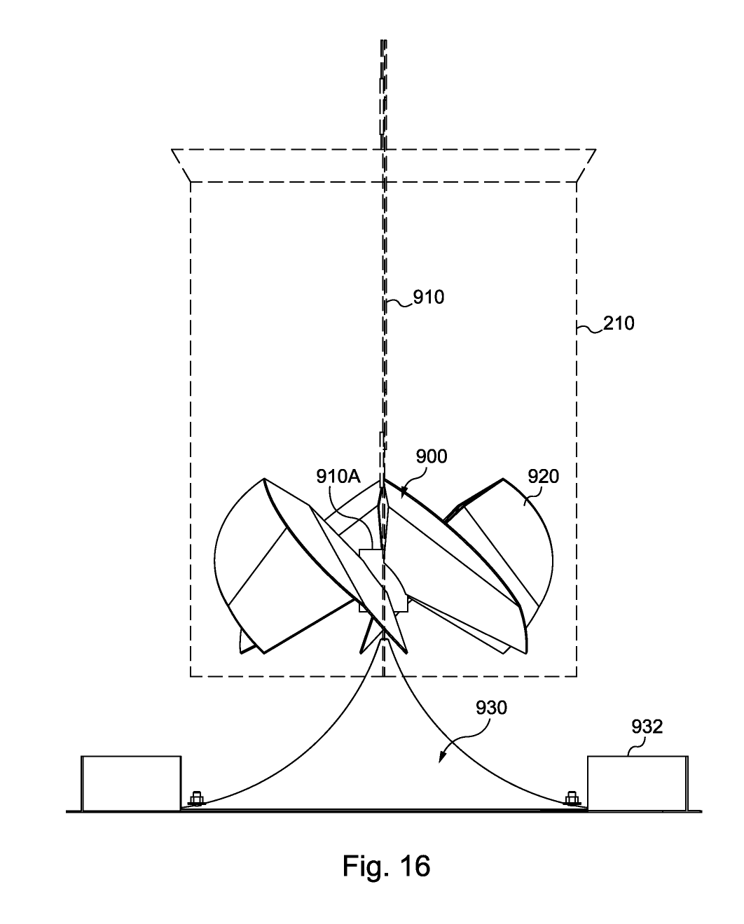

FIG. 16 is an elevation thereof.

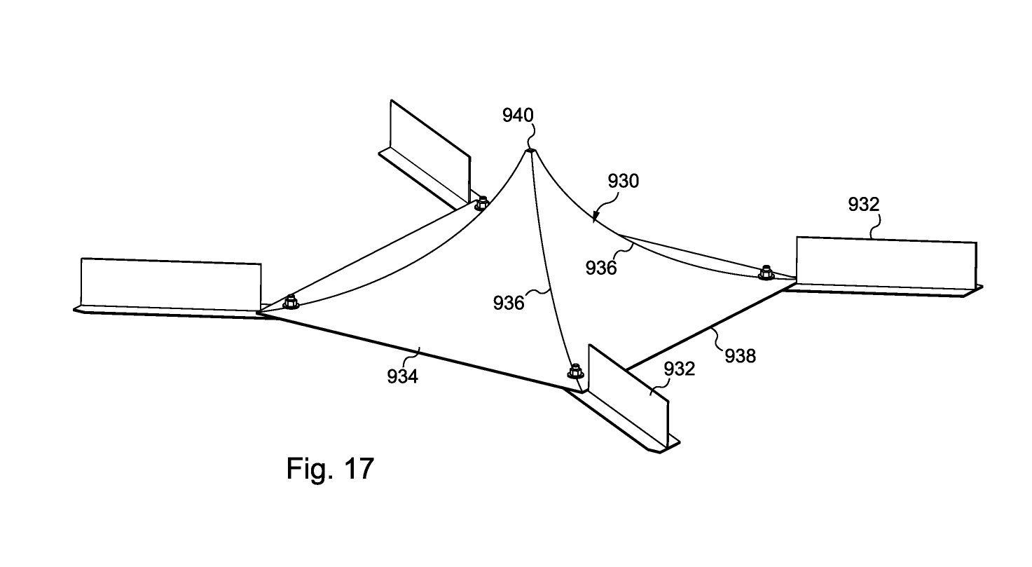

FIG. 17 is a perspective view of the static obstacle, with ribs in the extension of the edges.

In FIG. 1, a stirrer 100 is shown that can be used generally in a vat for bringing a liquid species into contact with a solid species. This stirrer comprises a shaft 110 about which it is driven in rotation (for example through the action of a motor, not shown) and blades 120 generally evenly distributed around the shaft 110 and the shape and the arrangement of which, in general identical for all the blades, allows the rotating stirrer to exert an axial thrust 130 (also called longitudinal thrust) on the liquid in which it is submerged. The number of blades of the stirrer 100 is at least two, but the more blades the stirrer comprises, the better the performance of the device.

Generally, such a stirrer can be placed in a flow-guide tube, which is a device constituted essentially by a hollow cylinder, generally with a circular base, separating an inner zone in which a fluid driven by the axial thrust 130 flows and an outer zone in which the fluid is generally driven in a movement parallel to the axial thrust 130, but in the opposite direction. The presence of such a flow-guide tube makes it possible to reduce the rotation speed of the stirrer. In fact, the flow-guide tube transforms part of the radial thrust created by the stirrer into axial thrust.

In FIG. 2, a contact vat 200 comprising a stirrer 100 and a flow-guide tube 210 is shown. Here, the blades 120 of the stirrer are entirely present inside the internal space of the flow-guide tube 210. The shafts of the flow-guide tube 210 and the stirrer 100 are aligned. The vat 200 is made of concrete or constitutes a civil engineering structure.

In FIG. 2, the lower part of the vat 200 in the extension of the flow-guide tube 210 and the stirrer 100 is occupied by a cruciform baffle as described in international patent application WO 2005/065832. This is constituted by two rectangular walls perpendicular to each other intersecting along a straight line parallel to their small side and situated halfway along their large side. This cruciform baffle is arranged so that the intersection line of the walls is in the extension of the shaft common to the flow-guide tube 210 and the stirrer 100. The cruciform baffle is referenced 230.

Still with reference to FIG. 2, the vat 200 is shown with the velocity vectors of the moving fluid that it contains.

In FIG. 3, the variability over time of the axial speed in the zone referenced 240 in FIG. 2 is shown. This zone is situated inside the flow-guide tube 210 at the height of the blades of the stirrer 100. FIG. 3 shows the very high variability of this speed, synonymous with unnecessary energy consumption and risks of shearing the solid species present in the zone 230.

In the space 250 between the centre of the blades of the stirrer 100 and the central axis of the cruciform baffle 220, the average direction of circulation of the fluid is from the cruciform baffle 220 towards the stirrer 100, contrary to the circulation in the rest of the inside of the flow-guide tube 210.

In FIG. 4, the iso-pressure surfaces with static pressure equal to −100 Pa with respect to the average in the space of the vat 200 are shown. A continuous ring around the cruciform baffle 220 can be seen, as well as the vortices extending into each of the four quarters of the space defined by the cruciform baffle 220, from the bottom of the stirrer 100.

These original observations have opened the way to improving the existing systems.

Furthermore, these simulation results are validated by comparison with the axial speed values obtained experimentally as a function of the distance with respect to the shaft (not shown).

Different propellers have been tested for the stirrer 100. In particular, propellers with four and eight blades comprising or not comprising an external cylinder surrounding the blades, and for the eight-blade configuration comprising or not comprising a central dome. These different propellers have been tested in a vat 200 provided with a flow-guide tube 210 and a cruciform baffle 220, this then being replaced either with a pyramid with eight faces as shown in FIG. 5, the faces of which extend to the summit, or the same pyramid with eight faces but with a truncated summit as shown in FIG. 6. The faces (or facets) of the pyramids are in this case identical, corresponding to an axial symmetry, and can be either flat or dished towards the top and away from the shaft.

Thus, a static obstacle having a generally regular shape around the shaft, for example a rotational shape, was chosen. But more particularly a rotational shape allows for excellent results to be obtained, in particular by avoiding the formation of vortices at the edges found with angular shapes. It should be noted that, in the case of axial symmetry with a pyramid shape, the greater the number of facets the closer it is to an exact rotational shape.

In FIGS. 7 and 8, a complete embodiment of the invention is shown. It comprises in a vat 200 and a stirrer 800 with eight blades 820 distributed evenly around the rotating shaft 810 driven via the top of the vat (not shown). A flow-guide tube 210 identical to that shown in the preceding figures is present and the distal ends of the blades 820 extend slightly beyond the lower part of the flow-guide tube.

The presence of a flow-guide tube is not indispensable, but generally, the stirrer is configured, in association with its optional flow-guide tube, to ensure the development of essentially longitudinal currents. If there are several stirrers, each of them is configured to ensure the development of essentially longitudinal currents.

A static obstacle 830 is arranged in the bottom of the vat 200. This static device 830 has a general rotational shape with a summit pointing towards the stirrer and a diameter increasing along the longitudinal shaft moving away from the stirrer 800 (this obstacle therefore has a circular cross-section unlike those in FIGS. 5 and 6). The maximum diameter of the static device 830 is reached on contact with the bottom of the vat 200. Here, this obstacle does not have a conical or truncated-cone shape, but a shape flared away from the shaft, with a curvature, which is constant or not constant, turned towards the outside. Preferably, the radius of curvature of the obstacle 830 in a plane comprising the shaft 810 is substantially constant over the greatest possible distance. It is chosen as a function of the dimensions of the base (or bottom) of the vat 200, so as to minimize the shears in the bottom of the vat, in which zone it is desirable that the fluid and the aggregates that it carries follow paths that are generally U-shaped, gentle and without energy loss or shears.

In FIGS. 7 and 8, the geometry of the bottom of the vat is shown as a square shape as well as the height of the vat which is approximately double the height of the flow-guide tube. The flow-guide tube 210 is placed in the present embodiment at equal distances from the bottom and from the top of the vat. In other arrangements, the blades of the stirrer could extend beyond one or other of the ends or openings of the flow-guide tube (or even be outside the latter). The diameter of the stirrer (and of the optional associated flow-guide tube) is typically at least of the order of one-third of the smallest width of the bottom of the vat.

In FIG. 9, which is a view in a plane perpendicular to the shaft 810, and FIG. 10, which is a view in a plane containing the shaft 810, the geometry of the static device 830 is shown in more detail. Its summit can be pointed, or conversely blunt. The rounded end 831 can be seen, which is essentially in the shape of a sphere.

Four ribs 832 are also shown rising from the surface of the static device 830 and running along the latter from an intermediate transverse section up to its external transverse section. Each of the ribs 832 emerges at a tangent to the perimeter of the intermediate transverse section. These ribs 832, unlike the rest of the static device 830, do not have a rotational geometry. They each constitute a projection with a projecting dimension parallel to the longitudinal shaft and with an approximately constant projection height over the entire length of the rib. Finally, the path of each rib 832 along the surface of the static obstacle 830 is, in projection in a transverse plane as shown in the upper part of FIG. 9, slightly curved with respect to a straight line, each of the ribs 832 tending, in the present embodiment, towards one of the corners of the square base of the vat 200 (not shown). The height of each of the ribs 832 is in this case substantially constant. These ribs can help to attenuate the rotational components induced by the stirrer in the downward fluid flow.

In FIG. 11, an example of the precise geometry of the blades 820 of the stirrer 800 is shown. Three views of the same blade are shown in three planes offset with respect to each other by 90°. The shaft 810 is shown in the three views. The blade 820 is a thin plate of material. Apart from its junction with the shaft 810, it is delimited by three edges that can be seen in FIG. 11. At its junction with the shaft 810 its surface is inclined by an angle A1 of 60° with respect to the transverse plane perpendicular to the shaft. At its distal end 822 (defined by the single edge that does not open onto the shaft 810), the blade 820 is inclined with respect to the transverse plane perpendicular to the shaft by an angle A2 of only 45° (in fact, the inclination A1 close to the shaft is advantageously greater than the inclination at the distal ends of the blades. This variation in angle between the shaft 810 and the distal part 822 of the blade results from the twisted character of the blade, capable of producing a longitudinal thrust of constant intensity as a function of the distance from the shaft. It should be noted that, since the blades in this case have, in each cross-section parallel to the shaft, a constant slope (which decreases moving away from the shaft), this slope is equal to the angle of attack (i.e. the inclination of the blades at their leading edge (upper edge).

More generally, at least one blade of the stirrer is twisted, and preferably all the blades are twisted, for example in the same manner. The shears and vortices are generally reduced.

The height D of the distal part 822 of the blade parallel to the longitudinal shaft is shown. In FIG. 8, the blades 820 extend beyond the lower opening of the flow-guide tube by approximately one quarter of the height D.

In FIG. 12, the cross-section of the static device 830 and the projection of the blade 820 in the plane A-A′ represented in FIG. 1 are shown. The radius of curvature R2 of the outer surface of the projection of the blade 820 is substantially constant. It is chosen as a function of the dimensions of the base of the vat, so as to limit the shear phenomena at the end of blade. Alternatively or in combination, it is chosen as a function of the dimensions of the static obstacle 830, for limiting the shears and the formation of vortices.

The inner surface 823 of the projection of the blade is parallel to the surface of the static obstacle 830, these two curves both having a constant radius of curvature R1. Due to this configuration, the paths of the fluid and the aggregates that it carries do not encounter the obstacle.

Parallel to the shaft 810, these two curves are a few tens of millimetres away from each other, this distance being referenced D′. It is chosen in relation to the dimension of the stirrer parallel to the shaft 810, for example the height D shown in FIG. 11, so that, in view of this dimension of the stirrer, the latter is not arranged too far from the static obstacle 830, thus guaranteeing the synergy effect that exists due to the adaptations of their reciprocal dimensions and which is apparent by the absence of counter-current flows in the extension of the shaft of the stirrer.

FIG. 13 shows the excellent results obtained with the static device 830 and the stirrer 800 implemented in the flow-guide tube 210 of the vat 200. The figure shows the velocity vectors of the fluid, and it is noted that at every point the latter takes a path tangential to the surfaces that it encounters.

FIG. 14 shows the isobaric surface of the fluid in FIG. 14 for the pressure value equal to −100 Pa. It is noted that this isobaric surface is only present in the flow-guide tube and above it. With respect to the representation in FIG. 4, it is noted in particular that the ring surrounding the static device and the vortices extending from the stirrer towards the bottom of the vat have disappeared.

FIGS. 15 to 17 show another embodiment of a device for bringing a liquid species into contact with a growing particulate solid species.

The components that are similar to those of the first embodiment are denoted by reference signs derived from those used for this first embodiment by adding the number 100.

This device thus comprises a vat provided with a stirrer 900 with blades 920 and a static obstacle 930 arranged in the extension of the shaft of the latter, downstream of it (in practice at a lower level, as, in the examples shown here, the flow generated by the stirrer is downwards). This stirrer 900 can be surrounded, as previously, by a flow-guide tube 210; it should be noted however that this stirrer does not extend beyond the flow-guide tube. It should also be noted that the flow-guide tube is shown here with vertical walls that project vis-à-vis its external vertical surface (which helps to ensure good linear flow upwards, outside this tube).

As previously, the blades 920 have an angle of attack which, at least at the ends is of the order of 45° (in this case 43°). However, unlike the blades 820, these blades 920 are not twisted but comprise bending lines transverse to the shaft (but not perpendicular to those nor coplanar with the shaft), separating upper flat (upstream) and lower (downstream) portions, the top part (helping to define the angle of attack in particular at the distal end) having a gentler slope with respect to the shaft than the lower part (by which these blades are fixed to the shaft, more precisely to a mounting hub 910A on the shaft).

These blades are in this case six in number and, in projection in a plane transverse to the shaft overlap, producing coverage of the order of 110%, which helps to ensure good entrainment of the flow.

Other numbers of blades can be chosen, preferably but not necessarily even numbers, with an angle of attack preferably comprised between 35° and 55°.

As previously, the stirrer (this is also the case for the flow-guide tube) covers the static obstacle, i.e. the bottom part of the blades (close to their distal ends) descend in immediate proximity to the top part of the static obstacle (its central part), or even lower (see FIG. 16). It should be noted that, also in this embodiment, the static obstacle and the stirrer are, at least at one point, longitudinally separated by a distance smaller than the longitudinal dimension of the stirrer.

While the static obstacle 830 has, precisely, a rotational shape about the shaft, the static obstacle has the shape of a pyramid, with facets that are advantageously identical, which corresponds to an axial symmetry. More precisely, this obstacle 930 is a pyramid with four facets 934 separated by edges 936, resulting in a square outline where it joins the bottom of the vat. However, as previously, this obstacle has, in axial cross-section, a concavity orientated upwards and away from the shaft; this concavity is moreover, as in the first embodiment, constant, with a constant radius of curvature from the summit to close to the bottom.

Preferably, the facets of the pyramid are portions of a cylinder in the mathematical sense of the term, i.e. they are formed by a straight line (horizontal i.e. perpendicular to the shaft) moving parallel to itself along a generatrix (namely the line with the steepest slope, in axial cross-section). In a variant, these facets can have a double curvature, for example concave upwards and away from the shaft in axial cross-section and convex in transverse cross-section; it is understood however that the configuration shown can be simpler to produce than a double curvature configuration.

This radius of curvature of the static obstacle in a plane comprising the shaft is in this case also comprised between one quarter of a reference transverse dimension of the vat and one and a half times said reference transverse dimension of the vat.

It can be verified that also in this case (see FIG. 15), the maximum value of the outer transverse dimension of the static obstacle (diagonal of the square section close to the bottom) is at least equal to the maximum transverse dimension of the stirrer and/or the flow-guide tube when it exists; similarly, the axial dimension of the static obstacle (its height) is at most equal to half of the maximum value of said outer transverse dimension (in fact, in the example shown, this axial dimension is even at most equal to half of the side 938 of this static obstacle close to the bottom (see FIG. 16)).

As previously, it should be noted that the outer surface of the static obstacle has, in any plane passing through the shaft (see in particular FIG. 16), an average inclination of at least 45° with respect to this shaft.

Similarly, the outer surface of the static obstacle is connected to the bottom of the vat, also in this case, at least approximately tangentially, at an angle in this case of at most 15° (the angle of connection with the bottom is here substantially smaller than that for the obstacle 830).

In variant (not shown), the shape dished upwards and away from the shaft can be approximated by an axial succession of portions of constant slopes, these slopes increasing from one portion to another moving away from the stirrer.

By analogy with the obstacle 830, the static obstacle can comprise ribs along its outer surface.

However, advantageously, it is possible to dispense with such ribs on the outer surface of the obstacle in the case of such a pyramid formed by a circumferential succession of facets separated by edges, while arranging them along the surface of the bottom of the vat. Such ribs 932 are advantageously arranged in the extension of at least some of the edges of the pyramid, preferably in the extension of each them (with an optional curvature moving away from this obstacle). These ribs are advantageously fixed to the static obstacle.

These ribs can extend from the corners of the static obstacle to the corners of the bottom of the vat, thus contributing to convenient positioning of the obstacle vis-à-vis the bottom. Moreover, these ribs can be both fixed to the static obstacle and to the bottom of the vat, which helps to reinforce the fixing of the obstacle to the bottom of the vat.

By way of example for a vat with a square bottom with sides of 2 m and a height of 2 m, the static obstacle with a square base has 1 m sides along the bottom and a height of 35 cm (assuming a constant radius of curvature).

The invention can be implemented without a flow-guide, in a vat having a base the dimensions of which are large with respect to the diameter of the blades of the stirrer, or with a blade stirrer capable of exerting a thrust the longitudinal component of which is significantly greater than the radial component.

The embodiment that has been presented uses a vat 200 with a square base. But if the base of the vat 200 is a circle, the reference transverse dimension to be used for dimensioning the stirrer 800 or 900 and the static obstacle 830 or 930 is the diameter of the base of the vat. If the base of the vat is a rectangle, then it is the short side thereof. If the base of the vat is a polygon, the hydraulic diameter thereof is preferred.

The invention is not limited to the embodiments presented but extends to all the variants within the scope of a person skilled in the art within the context of the main claims; in particular, features of the two embodiments that have been described can be combined.

1-22. (canceled)

23. Device for bringing a liquid species into contact with a growing particulate solid species, comprising a vat in which a blade stirrer is arranged in rotation about a shaft, the vat comprising a static obstacle generally centered about said shaft in an extension of the stirrer, characterized in that the static obstacle has an outer surface having, in a plane passing through the shaft, an outer transverse dimension that increases moving away from the stirrer parallel to said shaft, with a constant or increasing slope with respect to the shaft.

24. The device according to claim 23, in which the static obstacle is covered axially by the stirrer or by a flow-guide tube.

25. The device according to claim 23, characterized in that the static obstacle and the stirrer are, at least at one point, longitudinally separated by a distance smaller than the longitudinal dimension of the stirrer.

26. The device according to claim 23, in which the maximum value of the outer transverse dimension of the static obstacle is at least equal to the maximum transverse dimension of the stirrer or of a flow-guide tube.

27. The device according to claim 23, in which an axial dimension of the static obstacle is at most equal to half of the maximum value of said outer transverse dimension.

28. The device according to claim 23, in which the outer surface of the static obstacle has, in any plane passing through the shaft, an average inclination of at least 45° with respect to the shaft.

29. The device according to claim 23, in which the outer surface of the static obstacle is connected to the bottom of the vat at least approximately tangentially, at an angle of at most 15°.

30. The device according to claim 23, in which the outer surface of the static obstacle comprises at least one zone which, in an axial plane, is dished with a concavity orientated away from the shaft.

31. The device according to claim 30, characterized in that a radius of curvature of the static obstacle in a plane comprising the shaft is between one quarter of a reference transverse dimension of the vat and one and a half times said reference transverse dimension of the vat.

32. The device according to claim 30, in which the outer surface of the static obstacle comprises an axial succession of portions with constant slopes, these slopes increasing from one portion to another moving away from the stirrer.

33. The device according to claim 23, characterized in that the static obstacle has a generally regular shape about the shaft.

34. The device according to claim 23, characterized in that the static obstacle comprises at least two ribs along the outer surface.

35. The device according to claim 23, in which the outer surface of the static obstacle has the shape of a pyramid formed by a circumferential succession of facets separated by edges.

36. The device according to claim 35, in which the bottom of the vat comprises ribs extending transversally away from the shaft.

37. The device according to claim 23, wherein the blade stirrer comprises twisted blades.

38. The device according to claim 23 wherein the blade stirrer includes blades having ends and wherein the blades include an angle of attack at the ends of between 35° and 55° with respect to the shaft.

39. The device according to claim 23, in which the maximum value of the outer transverse dimension of the static obstacle represents at least one-third of the smallest transverse dimension of a bottom to which this static obstacle is fixed.

40. The device according to claim 23, characterized in that the stirrer is inserted at least partially into a flow-guide tube.

41. The device according to claim 23, characterized in that in a plane comprising the shaft, the inner surface of blades forming a part of the blade stirrer has a projection parallel to the outer surface of the static obstacle.

42. The device according to claim 23, characterized in that in a plane comprising the shaft, the outer surface of blades forming a part of the blade stirrer has a circular projection radius of curvature of between one-eighth of a reference transverse dimension of the vat and half of said reference transverse dimension of the vat.

43. The device according to claim 23, characterized in that in a plane comprising the shaft, the outer surface of blades that form a part of the blade stirrer has a circular projection radius of curvature of between half of a radius of curvature of the outer surface of the static obstacle and twice said radius of curvature of the outer surface of the static obstacle.

44. A method of bringing a liquid species and a growing particulate solid species into contact within a vat, according to which, using a blade stirrer rotating about a shaft, the two species are mixed along this shaft, towards a static obstacle generally centered around said shaft in the extension of the stirrer, characterized in that generally U-shaped paths are imposed on these mixed species via the static obstacle, the static obstacle having an outer transverse dimension that increases moving away from the stirrer parallel to said shaft, with a constant or increasing slope with respect to the shaft.
